(19) United States
(12) Patent Application Publication
(10) Pub. No.: US 2024/0193514 A1
(43) Pub. Date: Jun. 13, 2024

(54) QUANTUM COMPUTING ENABLED CONSTRUCTION PLANNING

(71) Applicant: Schlumberger Technology Corporation, Sugar Land, TX (US)

(72) Inventor: Rodney William Lessard, Menlo Park, CA (US)

(21) Appl. No.: 18/537,935

(22) Filed: Dec. 13, 2023

Related U.S. Application Data
(60) Provisional application No. 63/387,171, filed on Dec. 13, 2022.

(51) Int. Cl. G06Q 10/0631; G06Q 50/08

(52) U.S. Cl. CPC G06Q 10/06313; G06Q 50/08

(57) ABSTRACT

A method implements quantum computing enabled construction planning. The method includes applying an assignment model to project data using a quantum computing system to create an assignment schedule to assign a machine to a location at a time. The method further includes applying a scheduling model to the project data and the assignment schedule using a classic computing system to create an operation schedule to assign an operation to the location during the time with the machine. The method further includes performing an action responsive to the operation schedule.

### CROSS REFERENCE TO RELATED APPLICATIONS

This application claims the benefit of U.S. Provisional Application 63/387,171, filed Dec. 13, 2022, which is incorporated herein by reference to the extent allowed by applicable rules and law.

### BACKGROUND

Well construction planning considers the sequential allocation of multiple drilling platforms (also referred to as machines) to numerous well locations as part of a field development strategy. Once allocated to a location, a drilling platform facilitates the construction of one or more wells. The duration of construction of each well may vary depending on several factors such as depth, formation, and completion design. The construction of a single well (also referred to as jobs) may be broken down into numerous sequential operations some of which use specialized equipment and crews that are shared across active platforms. The purpose of planning is to ensure the efficient allocation of resources with a goal to complete construction of the field as early as possible, with the least amount of cost or other metrics such as profitability, reduced carbon emissions or contractual obligations. Such planning problems are difficult to optimize due to the exponential growth of the number of decision combinations, such as the allocation and order of assignment of a drilling platform to each well location and the start time of each construction operation such that operations that use the limited shared crews or equipment do not overlap more than the number of crews available. A challenge is to schedule the assignment of machines to locations and to schedule the jobs performed at the locations with minimal inactive time.

### SUMMARY

In general, in one or more aspects, the disclosure relates to a method implementing quantum computing enabled construction planning. The method includes applying an assignment model to project data using a quantum computing system to create an assignment schedule to assign a machine to a location at a time. The method further includes applying a scheduling model to the project data and the assignment schedule using a classic computing system to create an operation schedule to assign an operation to the location during the time with the machine. The method further includes performing an action responsive to the operation schedule.

Other aspects of the one or more embodiments may be apparent from the following description and the appended claims.

### BRIEF DESCRIPTION OF DRAWINGS

FIG. 1 shows a diagram in accordance with one or more embodiments.

FIG. 2.1, FIG. 2.2, FIG. 2.3, FIG. 3.1, and FIG. 3.2 show methods in accordance with one or more embodiments.

FIG. 4 show an example in accordance with one or more embodiments.

FIG. 5 shows an example of well construction operations in accordance with one or more embodiments.

FIG. 6 shows a flowchart in accordance with one or more embodiments.

FIG. 7 shows an example of binary variables representing an assignment of machines in accordance with one or more embodiments.

FIG. 8 shows a flowchart of a heuristic algorithm in accordance with one or more embodiments.

FIG. 9 shows an example of well constructions as scheduled in accordance with one or more embodiments.

FIG. 10 shows an example of well construction as scheduled in accordance with one or more embodiments.

FIG. 11 shows a graph of a comparison of scheduling procedures in accordance with one or more embodiments.

FIG. 12 shows a graph of an assignment in accordance with one or more embodiments.

FIG. 13.1 and FIG. 13.2 show a computing systems in accordance with one or more embodiments.

Similar elements in the various figures are denoted by similar names and reference numerals. The features and elements described in one figure may extend to similarly named features and elements in different figures.

### DETAILED DESCRIPTION

Embodiments of the disclosure implement quantum computing enabled construction planning. The construction planning may be stored in project data and may be for the construction of multiple wells at multiple geophysical locations. The construction of the wells may include transporting machines (also referred to as rigs) to the locations to build the well. Assigning the machines to locations in an order that minimizes time and cost may be similar to the traveling salesman problem, which is quadratic in nature and difficult for classic computing systems to solve in a reasonable amount of time. The planning of the construction may use a quantum computing system to apply an assignment model to the project data to create an assignment schedule that assigns the machines to the locations. A scheduling model is applied to the project data and the operation schedule to assign operations for building the wells at the locations during the times that the machines are at the locations. A job is performed at a location and includes a sequence of operations. Operation scheduling is linear in nature and may be performed with a classic computing system.

Operational research technology for solving allocation and scheduling problems have been developed over the past few decades but still struggles today to efficiently solve large scale problems. One or more embodiments are directed to a hybrid quantum and classical computing procedure that efficiently finds solutions to large scale well construction planning problems enabling the planning of larger fields, inclusion of more detailed operations, or more frequent re-optimizations as new information arises. One or more embodiments may enable a performance improvement over purely classical algorithms and, when classical algorithms may not solve the problem in a reasonable timeframe. For example, one or more embodiments may exhibit the ability to derive a solution that is may be better than any heuristic method by 10-20% in the problem makespan (time to complete the construction of the wells).

In general, embodiments are directed to a hybrid quantum and classical computing procedure that aims to improve the performance and scalability of solving scheduling problems with large numbers of physical machinery, geographic locations in which the physical machinery is to be placed and used, and operations at each geographic locations. One or more embodiments further account for the travel time of a machine to each job location.

One or more embodiments use a hybrid quantum and classical computing procedure that efficiently finds solutions to large scale well construction planning problems. Although applied specifically to well construction, the same methodology may also be used for similar construction problems like building construction and tunnel construction. In building and tunnel construction, the discussion below for a drilling rig may be applied to a large crane or to boring equipment. In another example, the machine may be a wireline truck that performs formation evaluation, well integrity measurement, or seismic sensing. In such a scenario, the construction project is the seismic sensing operations and the machine is the large truck that performs the seismic sensing operations.

Machines, such as drilling rigs, cranes, boring equipment, and seismic trucks have the properties of using a large amount of time or cost to move machine from one location to the next location. The machine may take multiple hours or even days. Further, such machines may have resource usage and time to take the machines apart and scheduling the machines to move on public roadways. Additionally, the scheduling accounts for the myriad of jobsites (i.e., individual geographic locations), each with corresponding timings for being the source or target location in transporting the machines. Thus, the scheduling problem is not a linear problem, but rather a quadratic problem.

To address the above, one or more embodiments use a hybrid approach of a quantum computer and a classic computer for scheduling construction. In the hybrid approach, the quantum computer is used to assign the machine that is used in the construction projection to each job location having the construction project while accounting for time and cost. The construction of the machine includes both scheduling of the transportation of the parts of the machine to a jobsite and the scheduling of putting the parts together to build the machine at the jobsite. Specifically, the quantum computer assigns a machine to each jobsite by considering, as input, the duration of the operations at the jobsite and the time to setup and move the machine from one jobsite to the next jobsite. The hybrid approach then uses the standard or classic binary based computer to schedule the detailed operations to complete each construction project at the jobsites. The standard or classic binary based computer schedules the jobs to perform the overall construction project. For example, the standard or classic computing system schedules the operations within each jobsite such that the same team does not overlap or exceed the number of teams available.

For example, the cementing operation at a wellsite may be done by a cementing team that moves between the active jobsites to complete the cementing of a section. There are generally less cementing teams then rigs as the cementing teams are used for part of the construction of a well. If, for example, ten rigs are active in constructing the well and two cementing teams are available, then two cementing operations may occur at the same time. The classic computing system may pause the well construction until a cementing team is available. The more cementing team available, the less down time but the higher cost and the more time the cementing team may be idle waiting for an operation to become available. Thus, quantum computing system takes care of determining which rig gets sent to each well and when. The classic computing system takes care of determining which crew gets sent to each job to complete a specific operation.

Consider the problem of scheduling many jobs each having several ordered operations of varying duration. Each job uses a machine that moves between different job locations. The time to move the machine between locations is significant and cannot be excluded in the computation of the total duration to complete the jobs. Since each job may have a different duration, the assignment of machines to jobs impacts the total duration to complete the jobs. This is known as the makespan of the problem. Additionally, some of the job operations are to be completed by a limited number of operation specific teams that are free to be deployed to any job location. The number of these shared teams is less than the number of machines so it is possible that a job may have to wait for the availability of a specific team which increases the job duration. A planner may have several objectives when allocating jobs and scheduling operations: minimize the makespan, the travel time of machines between job locations, and or the amount of time the machines are idle. An example is shown in FIG. 4.

For the job of constructing wells, the machines are drilling rigs and the operations are generally alternating drilling, casing, cementing operations followed by possibly production section logging and installation of production equipment like production strings, packers, or artificial lift systems. FIG. 5 shows an example of well construction operations. A subset of the well construction operations is the rig construction operations of the drilling rig to drill the well.

One or more embodiments use hybrid quantum and classical computing procedure for solving difficult machine assignment and operation scheduling problems for the construction of wells in the oil and gas industry. The same procedure could be applied to other planning problems in our domain and others which include both quadratic machine assignment and linear operation scheduling. Variations to the problem could include numerous additional constraints and objectives as described above, minimizing makespan, machine idle or machine travel time or any scaled combination of these.

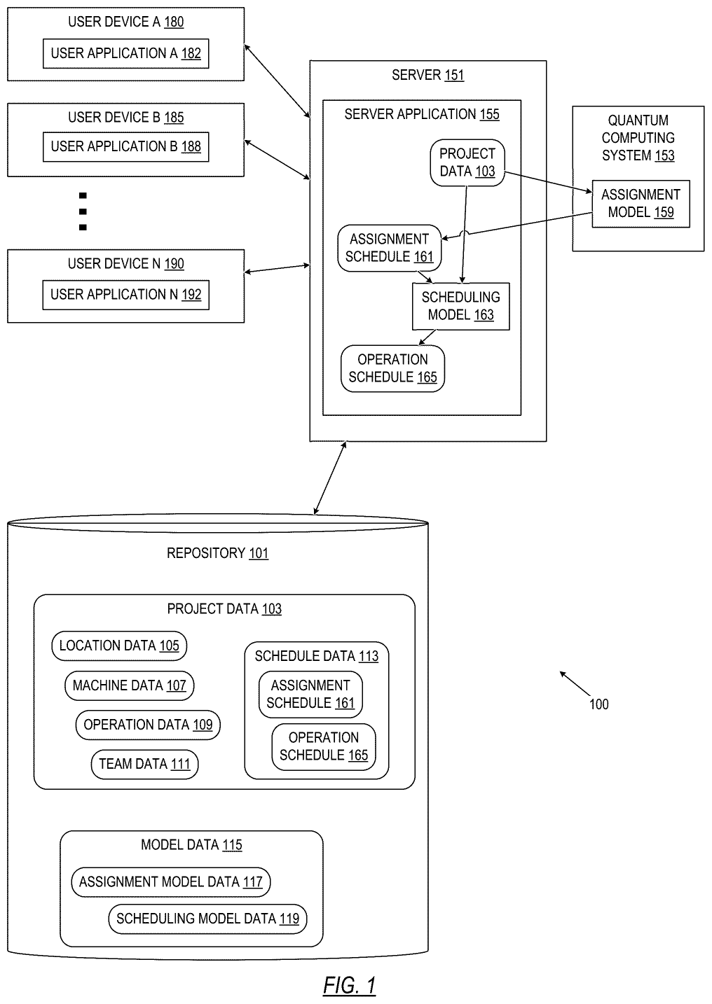

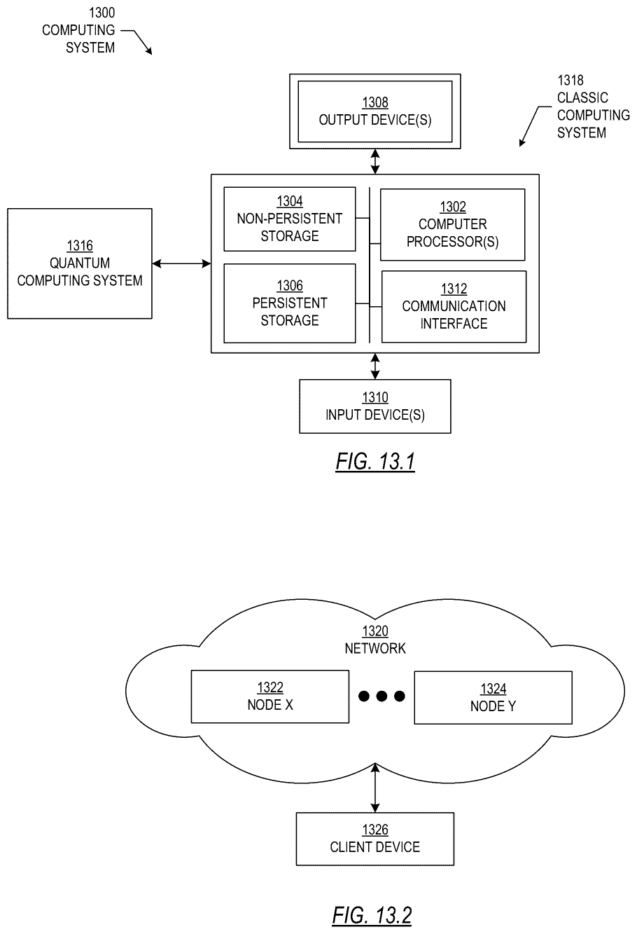

Turning to FIG. 1, the system (100) is a computing system shown in accordance with one or more embodiments. The system (100) and corresponding components may utilize the computing systems described in FIGS. 13.1 and 13.2 to implement construction planning using a hybrid of a quantum computing system (e.g., the quantum computing system (153)) and a classic computing system (e.g., the server (151)). The system (100) includes the repository (101), the server (151), the quantum computing system (153), and the user devices A (180) and B (185) through N (190).

The repository (101) is a type of storage unit and/or device (e.g., a file system, database, data structure, or any other storage mechanism) for storing data. The repository (101) may include multiple different, potentially heterogeneous, storage units and/or devices. The repository (101) stores data utilized by other components of the system (100). The data stored by the repository (101) includes the project data (103) and the model data (115).

The project data (103) records information about construction projects in the repository (101). The project data (103) may be updated in real time as construction projects and corresponding operations are performed. The project data (103) includes the location data (105), the machine data (107), the operation data (109), the team data (111), and the schedule data (113).

The location data (105) records information about the locations of projects. The location data (105) may include location identifiers to identify different locations, geophysical coordinates (e.g., longitude and latitude) for the locations, topographical maps of the locations, etc.

The machine data (107) records information about the machines for a project. The machine data (107) may include machine identifiers to identify different machines, machine descriptions information to identify the components of the machines, machine status information to identify the status of the machines and corresponding components, etc.

The operation data (109) records information about the operations for a project. The operation data (109) may identify the types of operations, the duration of time for completion of the operations. The times for operations may include start times and end times that may be scheduled or actual. The operation data (109) may further include descriptions of the operations to be performed.

The team data (111) records information about the teams that perform the operations of a project. The team data (111) may include team identifiers to identify different teams that work on a project. The team data (111) may enumerate the different types of teams and identify the individual people that make up the teams. The people of the teams may be users of the system (100).

The schedule data (113) records information about the schedules for machine assignments and operation assignments for locations. The machine and operation assignments are created as the assignment schedule (161) and the operation schedule (165) stored in the schedule data (113).

The assignment schedule (161) records the assignments of machines to locations. The assignment schedule (161) is a schedule that has an assignment of machines to locations. The assignments may include start times, durations, and end times for when a machine should be at a location.

The operation schedule (165) records the teams and order of operations performed at a location with a machine. The scheduling may include start times, durations, and end times for operations at a location and identify the team to perform the operation. The operation schedule (165) may identify a makespan. The makespan may be the span or duration of time. For example, the makespan may be the span of time taken to perform the operations for a construction project to build wells at the locations identified in the project data (103).

The model data (115) records information about the models used by the system, which may be machine learning models. The model data (115) includes the assignment model data (117) and the scheduling model data (119).

The assignment model data (117) records information about the assignment model (159) used by the system. The assignment model data (117) may include coefficients, weights, parameters, variable values, source code, executable code, etc.

The scheduling model data (119) records information about the scheduling model (163) used by the system (100). The scheduling model data (119) may include coefficients, weights, parameters, variable values, source code, executable code, etc.

Continuing with FIG. 1, the system (100) also may include the server (151). The server (151) is one or more classic computing systems, possibly in a distributed computing environment. A classic computing system performs calculations using “bits” where a bit may have a value of “1” or “0”. An example of the server (151) may be the computing system (1300) shown in FIG. 13.1.

The server (151) may host and/or execute one or more processes, software, applications, etc. For example, the server (151) may execute one or multiple instantiations of the server application (155) using different computing systems and servers. The server (151) may interact with the quantum computing system (153) and the user devices A (180) and B (185) through N (190).

The quantum computing system (153) utilizes quantum mechanical properties of matter to perform calculations, which may be performed much more efficiently than with classic computing systems. The quantum computing system (153) performs calculations using “qubits” where a qubit may have a value that may be a superposition of both “1” and “0” simultaneously. The quantum computing system (153) may execute the assignment model (159) to create the assignment schedule (161) from the project data (103).

The server application (155) is a collection of programs operating on the server (151). In an embodiment, the server application (155) uses the assignment model (159) (operating on the quantum computing system (153)) and the scheduling model (163) to generate the assignment schedule (161) and the operation schedule (165).

The assignment model (159) is a programming model that minimizes (or maximizes) an objective function based on a set of constraints using a set of decision variables. In an embodiment, the objective function for the assignment model (159) may be a quadratic function in which case the assignment model (159) is a quadratic programming model. The constraints of the assignment model (159) may be mathematical functions that specify equalities or inequalities to shape the feasible region of the optimization problem solved by the assignment model (159). The programming model of the assignment model (159) finds the values of the decision variables to minimize the objective function while satisfying the constraints. The decision variables for the assignment model (159) may represent when a machine is assigned to a location and the constraints may represent certain facts. For example, a machine may not be assigned to different locations at the same time and there may be an upper limit on the number of machines that is less than the number of locations.

The scheduling model (163) may also be a programming model that minimizes (or maximizes) and objective function based on a set of constraints based on a set of decision variables. In and embodiment, function for the scheduling model (163) may be a linear function in which case the scheduling model (163) is a linear programming model. The constraints of the scheduling model (163) may be mathematical functions that specify equalities or inequalities to shape the feasible region of the optimization problem solved by the scheduling model (163). The programming model of the scheduling model (163) finds the values of the decision variables to minimize the objective function while satisfying the constraints. The decision variables for the scheduling model (163) may represent when operations and teams are assigned to a job or location and the constraints may represent certain facts. For example, a single team may not be assigned different locations at the same time and a single team and a single operation may be assigned to each job or location at one time.

In an embodiment, the server application (155) loads and processes the project data (103) for input to the assignment model (159). The server application (155) may load the assignment model (159) to the quantum computing system (153) and input the project data (103) to the assignment model (159).

The assignment model (159) is a program that operates on the quantum computing system (153). The assignment model (159) receives input based on the project data (103) and generates the assignment schedule (161), which is input to the scheduling model (163).

In an embodiment, the server application (155) may process the assignment schedule (161) and the project data (103) for entry to the scheduling model (163). The scheduling model (163) processes the project data (103) and the assignment schedule (161) to generate the operation schedule (165) that assigns the teams and operations to the machines at the locations identified in the project data (103).

Continuing with FIG. 1, the user devices A (180) and B (185) through N (190) may interact with the server (151). The user devices A (180) and B (185) through N (190) may be computing systems in accordance with FIGS. 13.1 and 13.2. The user devices A (180) and B (185) through N (190) may include and execute the user applications A (182) and B (188) through N (192).

In one or more embodiments, the user device A (180) is operated by a user to update the project data (103) and generate one or more of the assignment schedule (161) and the operation schedule (165). Responsive to the user, the user device A (180) may interact with the server (151) to display messages automatically generated by the server application (155) that include information from one or more of the assignment schedule (161) and the operation schedule (165).

In one or more embodiments, the user device N (190) is operated by a user to process information generated by the system (100). The user device N (190) may receive messages, notifications, and alerts from the server (151) in response to updates to the assignment schedule (161) or the operation schedule (165).

Although described within the context of a client server environment with servers and user devices, aspects of the disclosure may be practiced with a single computing system and application. For example, a monolithic application may operate on a computing system to perform the same functions as one or more of the applications executed by the server (151) and the user devices A (180) and B (185) through N (190).

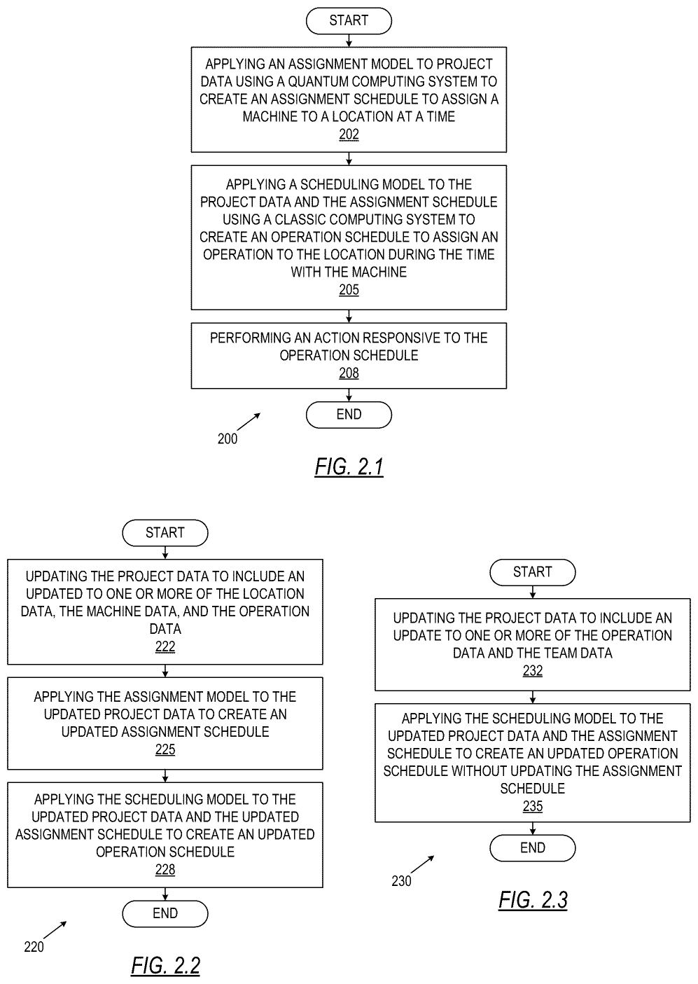

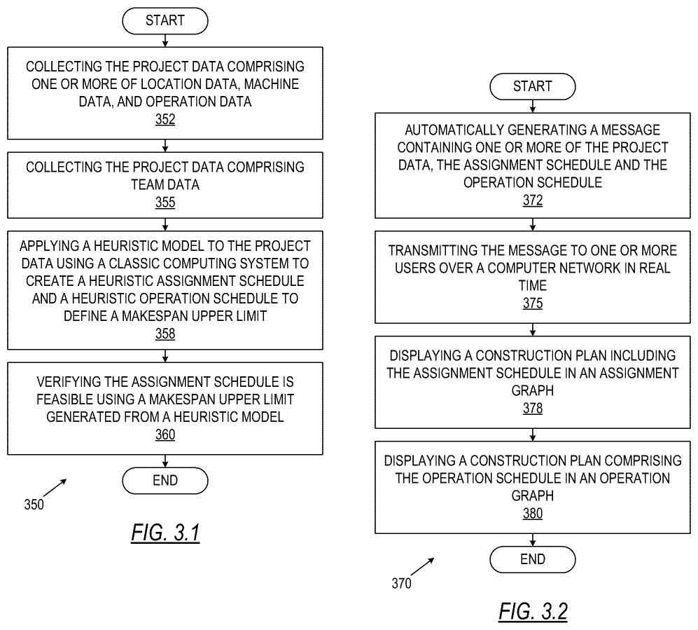

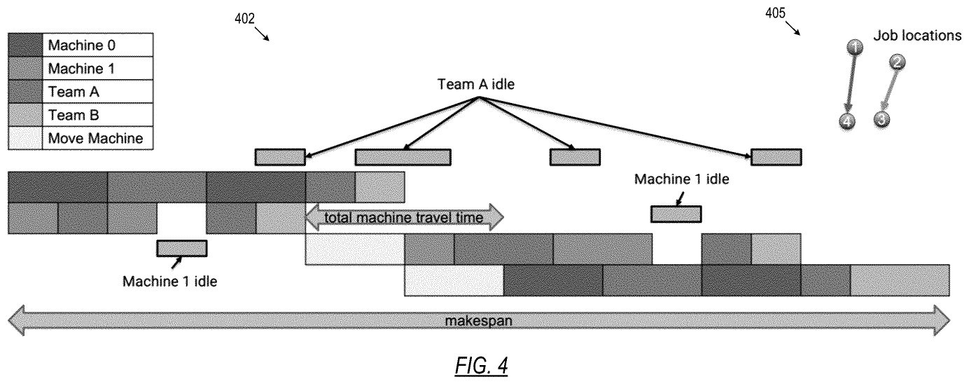

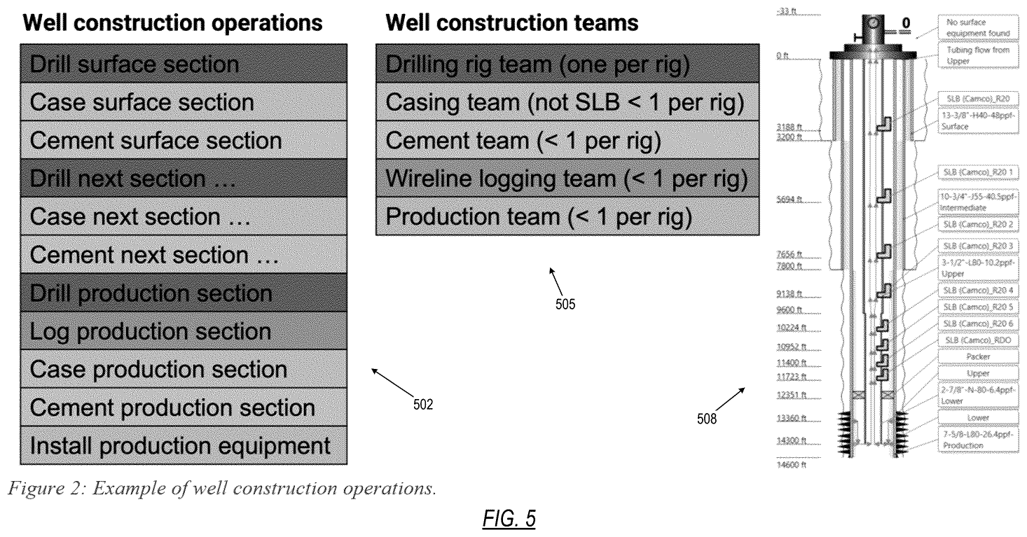

FIG. 2.1, FIG. 2.2, FIG. 2.3, FIG. 3.1, and FIG. 3.2 illustrate the processes (200), (220), (230), (350), and (370). In one embodiment, a system may include at least one processor and an application that, when executing on the at least one processor, performs one or more of the processes (200), (220), (350), and (370). In one embodiment, a non-transitory computer readable medium may include instructions that, when executed by one or more processors, perform the processes (200), (220), (350), and (370).

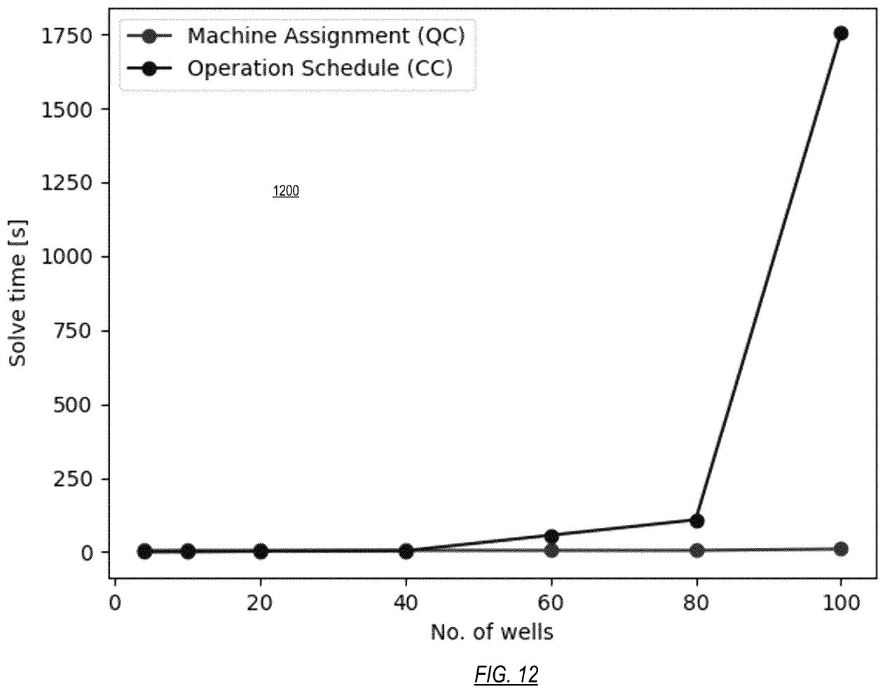

Turning to FIG. 2.1, the process (200) implements construction planning using a hybrid of a quantum computing system and a classic computing system. The process (200) includes multiple steps that may execute on the components described in the other figures, including those of FIG. 1 and FIG. 12A.

Block 202 includes applying an assignment model to project data using a quantum computing system to create an assignment schedule to assign a machine to a location at a time. In an embodiment, a classic computing system loads the assignment model to a quantum computing system and then loads the project data into the assignment model on the quantum computing system. The project data loaded into the assignment model may identify locations, machines, and the duration that is expected for a machine to be at a location to construct one or more wells at the location using the machine. The assignment schedule generated by the quantum computing system is received by the classic computing system and may correspond to a schedule that takes a least amount of time given the locations and the machines.

Block 205 includes applying a scheduling model to the project data and the assignment schedule using a classic computing system to create an operation schedule to assign an operation to the location during the time with the machine. After the assignment schedule is created, the assignment schedule may be processed with the project data to create an operation schedule using a classic computing system. The project data includes team data and operation data that the scheduling model uses with the assignment schedule to assign teams to operations performed at locations with machines at the locations.

Block 208 includes performing an action responsive to the operation schedule. The action may include generating and transmitting messages that include information from one or more of the assignment schedule and the operation schedule. The action may further include performance of an operation at the location with a machine.

Turning to FIG. 2.2, the process (220) further implements construction planning using a hybrid of a quantum computing system and a classic computing system. The process (220) includes multiple steps that may execute on the components described in the other figures, including those of FIG. 1 and FIG. 13.1.

Block 222 includes updating the project data to include an update to one or more of the location data, the machine data, and the operation data. In an embodiment, the update may be received in real-time from a computing system at a location. For example, construction at a location may be completed and the project data may be updated to remove the location from the list of locations to used to generate the assignment schedule.

Block 225 includes applying the assignment model to the updated project data to create an updated assignment schedule. Continuing the example, the assignment schedule may assign machines to locations for which construction has not been completed and may not include assignments to locations for which construction has been completed. In an embodiment, the assignment model is executed on demand in response to data received by the system. In an embodiment, the assignment model is executed periodically (e.g., daily, weekly, monthly, etc.) on project data updated throughout the period.

Block 228 includes applying the scheduling model to the updated project data and the updated assignment schedule to create an updated operation schedule. The updated operation schedule includes assignments to locations for which construction has not been completed and may not include assignments to locations for which construction has been completed. The scheduling model may be executed after execution of the assignment model in response to the updated assignment schedule being different than the original assignment schedule.

Turning to FIG. 2.3, the process (230) further implements construction planning using a hybrid of a quantum computing system and a classic computing system. The process (230) includes multiple steps that may execute on the components described in the other figures, including those of FIG. 1 and FIG. 13.1.

Block 232 includes updating the project data to include an update to one or more of the operation data and the team data. For example, the update may indicate that an operation is completed at a location.

Block 235 includes applying the scheduling model to the updated project data and the assignment schedule to create an updated operation schedule without updating the assignment schedule. For example, after an operation is completed, the team completing the operation may be reassigned to a different operation or location in the updated operation schedule as compared to the original operation schedule. In an embodiment, the scheduling model is executed on demand in response to data received by the system. In an embodiment, the scheduling model is executed periodically (e.g., daily, weekly, monthly, etc.) on project data updated throughout the period.

Turning to FIG. 3.1, the process (350) further implements construction planning using a hybrid of a quantum computing system and a classic computing system. The process (350) includes multiple steps that may execute on the components described in the other figures, including those of FIG. 1 and FIG. 13.1.

Block 352 includes collecting the project data, which may include location data, machine data, and operation data. In an embodiment, the operation data may include an operation schedule generated by the scheduling model. The operation schedule may enumerate operations identified as one of drill surface section, case surface section, cement surface section, drill next section, case next section, cement next section, drill production section, log production section, case production section, cement production section, install production equipment, etc.

Block 355 includes collecting the project data that includes team data, which may use team identifiers. The operation schedule generated by the scheduling model may identify teams using the team identifiers as one of a drilling rig team, a casing team, a cement team, a wireline logging team, a production team, etc. In an embodiment, the project data may identify one drilling rig team per machine, less than one casing team per machine, less than one cement team per machine, less than one wireline logging team per machine, and less than one production team per machine.

Block 358 includes applying a heuristic model to the project data using a classic computing system to create a heuristic assignment schedule and a heuristic operation schedule to define a makespan upper limit. In an embodiment, the heuristic model may sequentially assign machines to locations, which may not be efficient and lead to times when machines or teams are not being used or are not working to perform operations of the construction project.

Block 360 includes verifying the assignment schedule is feasible using a makespan upper limit generated from a heuristic model. If the makespan identified by the assignment schedule is greater (i.e., takes longer) than the makespan identified by the heuristic assignment schedule, then the assignment schedule generated utilizing the quantum computing system is not an improvement over the heuristic assignment schedule and is not verified. If the makespan of the assignment schedule is less than the makespan of the heuristic assignment schedule, then the assignment schedule is verified.

Turning to FIG. 3.2, the process (370) further implements construction planning using a hybrid of a quantum computing system and a classic computing system. The process (370) includes multiple steps that may execute on the components described in the other figures, including those of FIG. 1 and FIG. 13.1.

Block 372 includes automatically generating a message containing one or more of the project data, the assignment schedule and the operation schedule. The message may include updates to the assignment schedule and the operation schedule. In an embodiment, the message may be constructed according to one or more standards, including the JavaScript object notation (JSON) standard. In an embodiment, the messages generated by the system may be generated in response to updates to the project data, the assignment schedule, the operation schedule, etc.

Block 375 includes transmitting the message to a plurality of users over a computer network in real time. The message may be one of multiple messages transmitted to the users of the system.

Block 378 includes displaying a construction plan comprising the assignment schedule in an assignment graph. In an embodiment, the assignment graph is a visual representation of the machines assigned to the locations with the duration of the assignments. The assignment graph may be displayed on a user device that received a message from the system.

Block 380 includes displaying a construction plan comprising the operation schedule in an operation graph. In an embodiment, the operation graph is a visual representation of the operations performed at locations with the duration of the operations. The operation graph may be displayed on a user device that received a message from the system.

Turning to FIG. 4, an example is illustrated for a project with 2 machines and 4 jobs that each include 5 operations. The horizontal axis represents time and the vertical axis is used to disambiguate the 4 different jobs. One row on the graph (402) represents one job. The location graph (405) illustrates a representation of the different locations of the jobs and identifies the order of the jobs.

Machine 0 is used for the first (topmost) job and the fourth (bottommost) job. There is no idle time for Machine 0 once construction is started a location.

Machine 1 is used for the second and third jobs. Machine 1 is idle after the third operation and before the fourth operation of the second job. Machine 1 is also idle between the third and fourth operations of the third job.

Turning to FIG. 5, an example of well construction operations is illustrated. The list (502) enumerates multiple types of well construction operations. The list (505) enumerates multiple types of teams that may perform the operations identified in the list (502) at a location for a job. The diagram (508) illustrates a borehole of a well that is constructed at a location for a job.

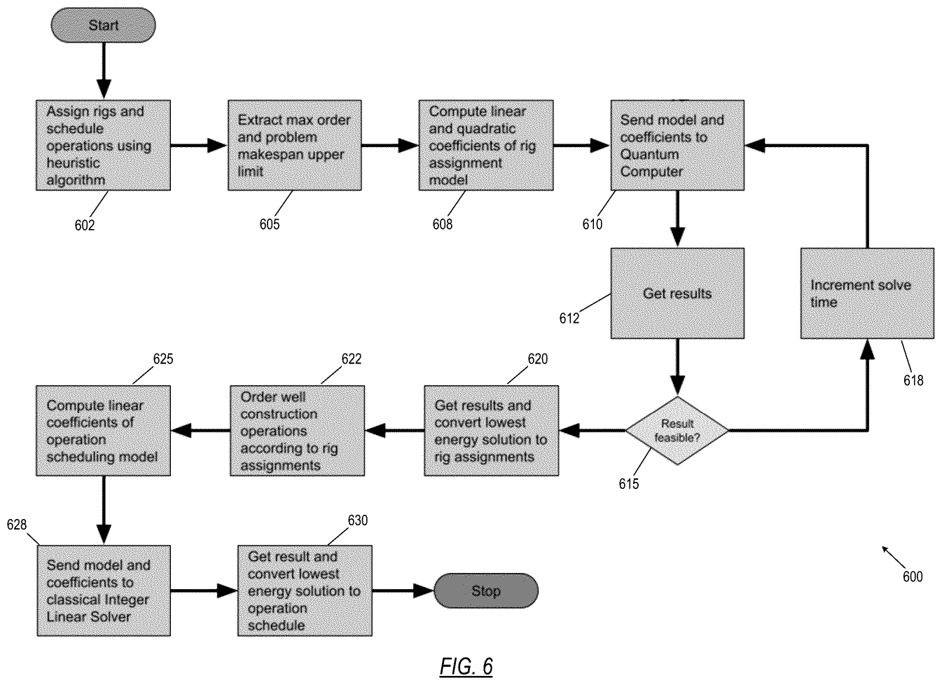

Turning to FIG. 6, the process (600) implements a hybrid quantum and classical procedure for optimizing well construction jobs. Block 602 includes assigning rigs and scheduling operations using a heuristic algorithm to form a heuristic assignment schedule and a heuristic operation schedule. Block 605 includes extracting a max order and problem makespan upper limit from the heuristic assignment schedule and the heuristic operation schedule. Block 608 includes computing linear and quadratic coefficients for the assignment model (referred to as the rig assignment model). Block 610 includes sending the model and coefficients to a quantum computer. Block 612 includes receiving results from the quantum computer and calculated from the model and coefficients sent to the quantum computer.

Block 615 determines whether the results from the quantum computer are feasible. When the results are feasible (e.g., a machine is assigned to each of the locations of the jobs for a construction project so that each of the jobs may be completed) the process (600) proceeds to the Block 618. Otherwise, the process (600) proceeds to the Block 620.

Block 618 includes incrementing the solve time. As an example, the initial results may not be feasible because there is not enough time to assign each of the jobs of a construction project. Incrementing the solve time may allow for enough time to assign each of the jobs of the construction project.

Block 620 includes getting the results and converting a lowest energy solution from the results to a set of rig assignments for an assignment schedule. Block 622 includes ordering well construction operations according to the rig assignments of the assignment schedule. Block 625 includes computing linear coefficients of a scheduling model (refers to as the operation scheduling model). Block 628 includes sending the scheduling model and coefficients to a classical integer linear solver that may operate on a classic computing system. Block 630 includes getting the results from the linear solver and converting the lowest energy solution from the linear solver results to an operation schedule.

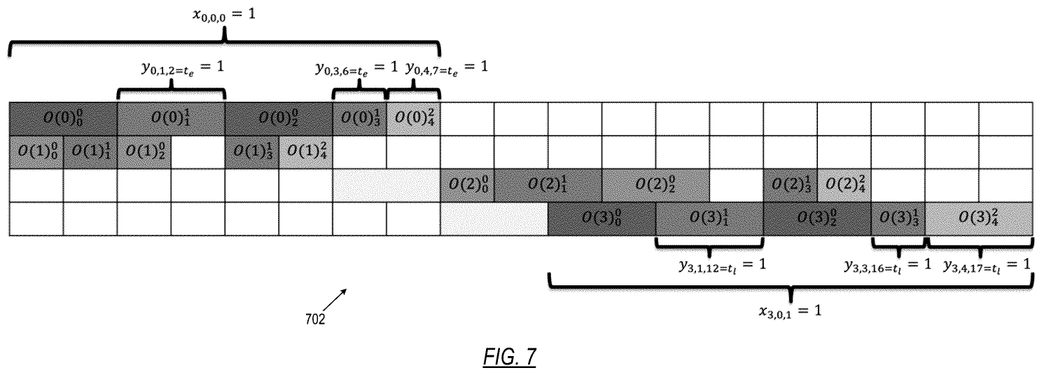

Turning to FIG. 7, the graph (702) illustrates an operation schedule that is formatted for processing by the system. The graph (702) includes binary variables x and y that represent the assignment of machines to jobs and start times of operations. Each row of the graph (702) corresponds to a job. Each column of the graph (702) corresponds to a time slot for the performance of an operation for a job at a location to which a machine is assigned. The graph (702) includes information from an assignment schedule assigning machines to jobs and locations and from an operation schedule assigning operations to jobs at locations with machines.

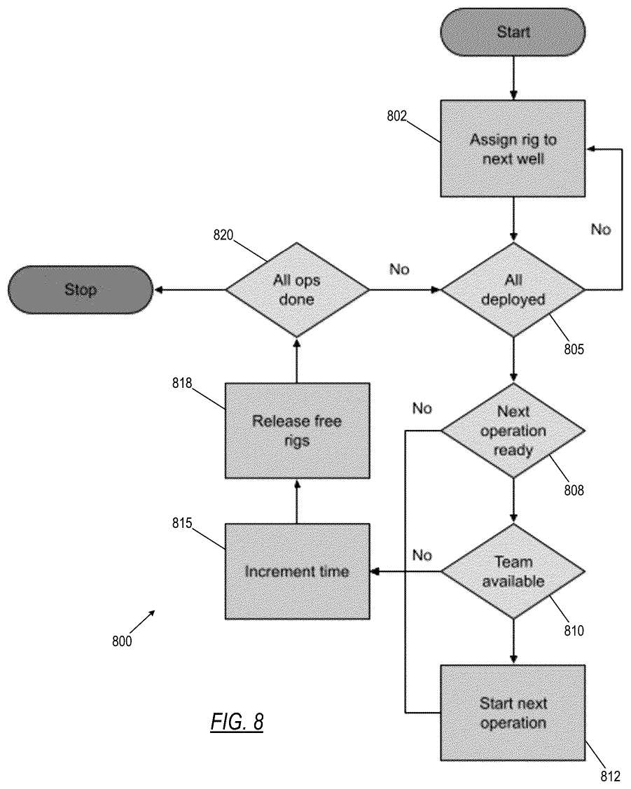

Turning to FIG. 8, the process (800) implements a heuristic algorithm to estimate bounds on problem variable ranges (e.g., a makespan upper limit). Block 802 includes the assigning a machine (referred to as a rig) to a location of a well to be constructed (also referred to as a job).

Block 805 includes determining whether each of the machines for a construction project have been deployed. If so, the process (800) proceeds to Block 808. If not, the process (800) proceeds back to Block 802 to assign a machine that has not been deployed.

Block 808 includes determining if a next operation is ready to be assigned. In other words, a determination is made as to whether each of the operations for a machine assigned to a location has been assigned. If a next operation is ready to be assigned, the process (800) proceeds to Block 810. Otherwise, process (800) proceeds to the Block 815.

Block 810 includes determining if a team is available. In other words, a determination is made as to whether each of the teams for the construction project that may be assigned to an operation of a job at a location with a machine have been assigned to an operation. If so, the process proceeds to Block 812. If not, this proceeds to Block 815.

Block 812 includes starting the next operation. The operation is started after a machine has been deployed to the location, operation has been assigned to the job at the location, and a team has been assigned to the operation.

Block 815 includes incrementing time. Time may be tracked hourly, daily, weekly, monthly, etc.

Block 818 includes releasing free machines. In an embodiment, free machine is a rig for which the operations of a job have been completed so that the rig may be assigned and moved to another location to perform another job.

Block 820 includes determining whether each of the operations are completed. If not, the process (800) proceeds back to Block 805 to deploy machines and then assigned operations and teams, which is repeated until each of the operations for each of the jobs is completed. If each of the operations for each of the jobs for the construction project have been completed, then the process (800) may stop.

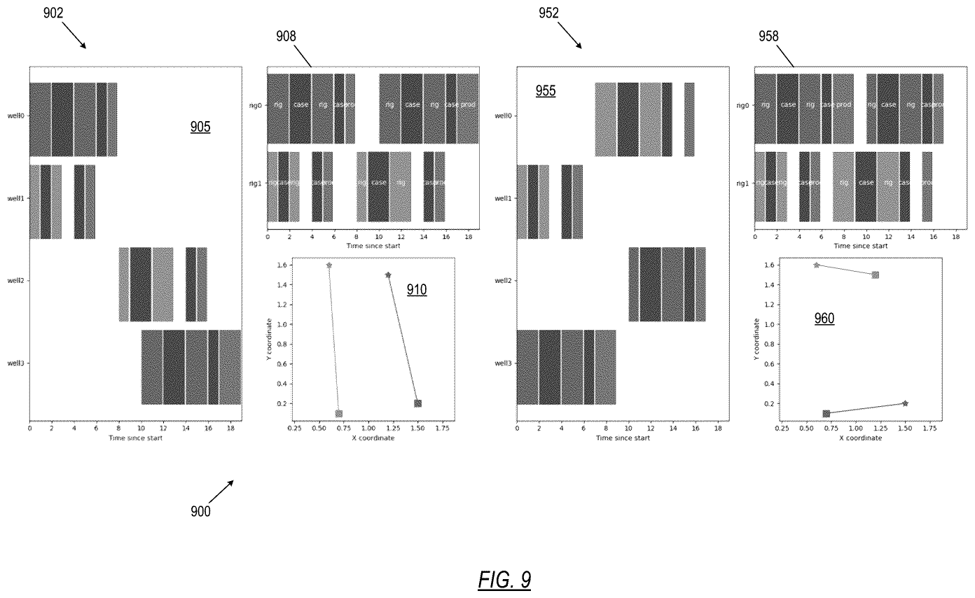

Turning to FIG. 9, the user interface (900) may be displayed on a user device with information from an assignment schedule and an operation schedule for the construction jobs of four wells using two machines. The user interface (900) includes the left panel (902) displaying a well-construction derived by the heuristic procedure. The right panel (952) of the user interface (900) includes a plan optimized by the quantum/classical procedure. Blocks in the panels (902) and (952) may be colored (e.g., blue and orange) to represent drilling operations of the two different machines (rigs) used in the construction project to perform the jobs to build the wells. Blocks in the panels (902) and (952) may further be colored (e.g., red and purple) to identify casing/cementing operations and production installation operations performed by a single shared crew without overlap. The scatter graphs (910) and (960) graphically illustrate well locations and travel paths for the machines. The graphs (905) and (955) show operation schedules with time as the horizontal axis and the different wells identified along the vertical axis. The graphs (908) and (958) show operations with time as the horizontal axis and the different machines identified along the vertical axis.

The graphs (955) and (958) show that the hybrid quantum classical computing system generated a schedule that takes 17 days. The graphs (905) and (908) show that the heuristic algorithm on the classic computing system generated a schedule that takes 19 days. Additionally, the scatter graph (960) shows that the machines are moved a shorter distance as compared to the distance the machines are moved as it shown by the scatter graph (910).

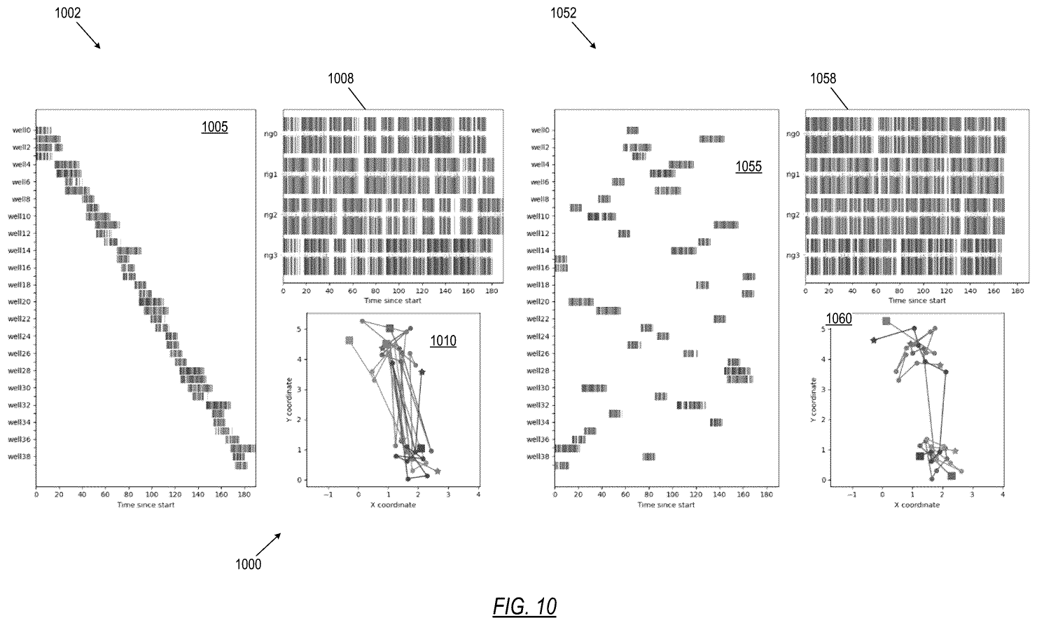

Turning to FIG. 10, the user interface (1000) may be displayed on a user device with information from an assignment schedule and an operation schedule for the construction jobs of 40 wells using four machines. The user interface (1000) is structured similar to that of the user interface (900) of FIG. 9 with the left panel (1002) and the right panel (1050). The left panel (1002) includes the graphs (1005), (1008), and (1010) generated with a heuristic algorithm and the right panel (1052). The right panel (1052) illustrates a construction plan generated using the quantum computing system that takes less than 180 days. The left panel (1002) illustrates a construction plan generated without the quantum computing system that takes more than 180 days.

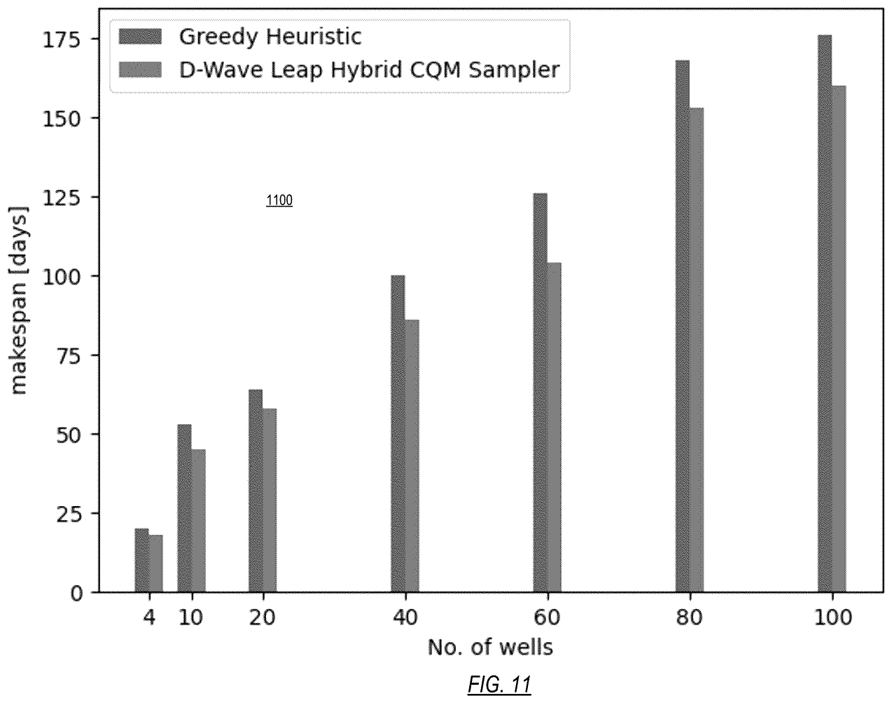

Turning to FIG. 11, the graph (1100) shows benefits of the hybrid quantum and classical procedure over the heuristic method. The horizontal axis identifies the number of wells analyzed and the vertical axis identifies the makespan (number of days) for the construction plans generated by the two methods. In each case, the makespan of the construction plan generated by the hybrid quantum and classical procedure is shorter than the makespan of the construction plan generated by the heuristic method.

Turning to FIG. 12, the graph (1200) illustrates the scaling for generating the assignment schedule (using a quantum computer and referred to as “Machine Assignment”) and generating the operation schedule (using a classical computer and referred to as “Operation Schedule”). The horizontal axis identifies the number of wells analyzed, and the vertical axis identifies the amount of time used to solve for the assignment schedule and the operation schedule. Using the quantum computer for the assignment schedule scales better staying near “0” even at 100 wells. Using the classical computer for the operation schedule does not scale as well reaching to 1750 seconds for 100 wells.

Next, a mathematical formulation is described that expresses the problem as multiple objective functions and constraints suitable for solving with quantum and classical computers.

### Problem Formulation

Consider the problem of completing a set of jobs J∈{J₀, . . . , J_{K-1}} each requiring the exclusive use of one of a set of identical machines M∈{M₀, . . . , M_{N-1}}. Each job is divided into a set of operations O(k)∈{O₀, . . . , O_{G-1}} of expected durations p(k)∈{p₀, . . . , P_{G-1}}. A subset of operations for each job, O(k)^{f}∈{O₀^{f}, . . . , O_{H-1}^{f}}, requires the assistance of specialized teams B E {B₀, . . . , B_{F-1}} that are free to move between jobs as needed. The number of each team available, L∈{L₀, . . . , L_{F-1}}, is usually less than the number of machines N requiring them to be shared and therefore scheduled based on availability so that no team specific operation may start when all those team are otherwise occupied. An example is shown in FIG. 4.

One or more embodiments formulate the machine assignment and operation scheduling problem as a set of binary decisions. The weights of the binary decisions are defined such that a linear or quadratic combination represents the objective and constraints of the problem.

### Hybrid Classical and Quantum Computing Procedure

An efficient procedure to solve this problem separates the difficult quadratic problem of machine assignment which may be quickly solved using a quantum computer from the linear operation scheduling problem, given the machine assignment solution, which may then be solved using traditional classical computing techniques such as branch and bound. The procedure is depicted in FIG. 6.

### Machine Assignment

Let x_{k,n,i}∈{0,1} represent the binary decision that job k is assigned to machine n in order i. The range of the order i is {0, . . . , M−1}. An upper bound of M is K, all jobs are assigned to the same machine, and a lower bound is K/N, jobs are evenly distributed. The optimum makespan may have M somewhere in between. One or more embodiments use a heuristic algorithm to find a reasonable estimate. This choice of binary representation requires several constraints to ensure only feasible solutions are obtained. The constraints may include: (1) Each job must be assigned to exactly one machine and order; (2) Each machine and order may be assigned at most one job; and (3) The order of each machine assignment must be sequential starting from zero, i.e., 0, 1, 2 and not 1, 2, 4. These constraints may be modeled as the following linear equalities or inequalities.

$${\sum }_{n = 0}^{N - 1} {\sum }_{i = 0}^{M - 1} {x}_{k , n , i} = 1 ∀ k ∈ \{ 0 , … , K - 1 \} .. \qquad Constraint 1$$

$${\sum }_{k = 0}^{K - 1} {x}_{k , n , i} \leq 1 ∀ n ∈ \{ 0 , … , N - 1 \} and i ∈ \{ 0 , … , M - 1 \} .. \qquad Constraint 2$$

$${\sum }_{k = 0}^{K - 1} {ix}_{k , n , i} - {\sum }_{k = 0}^{K - 1} {\sum }_{j = 0}^{i - 1} {x}_{k , n , j} \leq 0 ∀ n ∈ \{ 0 , … , N - 1 \} \qquad Constraint 3$$

$$and i ∈ \{ 0 , … , M - 1 \} ..$$

One or more embodiments seek to find an optimal assignment of machines to jobs so that the time to complete each of the jobs, including the time for the machines to move between jobs is minimized. An integer variable w∈{0, . . . , T} is defined that represents the duration of time to complete each of the jobs. The value of T is upper bound by the sum of all job durations, corresponding to each of the jobs being assigned to one machine, but again one or more embodiments use a heuristic algorithm that may find a sub-optimal problem solution giving a reasonable estimate for T. The value of w may be modeled as another constraint.

$$w \geq {\sum }_{k = 0}^{K - 1} {\sum }_{i = 0}^{M - 1} P ( k ) {x}_{k , n , i} ∀ k ∈ \{ 0 , … , N - 1 \} . \qquad Constraint 4$$

where P(k)=Σ_{g=0}^{G-1}p(k)_{g}. Since w is greater than the total duration of each of the jobs for each of the machines, the minimization of w may equal to the problem makespan. Note that embodiments may include the travel time between jobs here. The formulation above is defined to minimize the total travel time, not just for the machine with the greatest job duration.

Finally, one or more embodiments seek the solution x to the problem above that minimizes both the duration of time to complete each job and the total travel time of each machine.

$$min H ( x ) = w + {\sum }_{n = 0}^{N - 1} {\sum }_{k = 0}^{K - 1} {\sum }_{g > k}^{K - 1} {\sum }_{i = 0}^{M - 1} tt ( k , g ) ( {x}_{k , n , i} {x}_{g , n , i + 1} + {x}_{g , n , i} {x}_{k , n , i + 1} ) . \qquad Objective$$

where tt(k, g) is the travel time between job k and g. From the form of the objective, this is a quadratic problem and therefore very difficult to solve with classical technology as the problem size increases. Therefore, one or more embodiments use a quantum computer to find the optimal set of machines assignments which greatly simplifies the operation scheduling problem.

### Operation Scheduling

The next set of decisions are when each operation of each job should start and for this, a reasonable smallest unit of time is chosen so that start times are selected from a discrete set. For example, if operations take weeks to complete, the discrete unit of a day may be used. In the example, the casing operation is started at day 11 and it may take 3 days to complete. This allows embodiments to define the binary variable y_{k,g,t}∈{0,1} to represent the decision that operation g of job k should start in discrete element of time t(g(k))∈{tₑ, tₑ+1, . . . , tₗ}, where tₑ is the earliest possible start time of the operation and tₗ is the latest. The first operation of the first job assigned to a machine may start as early as tₑ=0 and subsequent operations must be later. Further, an upper bound on the latest start time of the last operation of the last job assigned to a machine is estimated. Again, one or more embodiments could assume the worst case that all jobs are assigned to the same machine so that the start time of the last operation of the last job is the sum of all operation durations not including itself. To increase the optimal solution, one or more embodiments may use a heuristic algorithm to estimate a reasonable upper bound T, i.e., the makespan of the problem as derived by the heuristic algorithm which assigns jobs and operations using a pool of resources. The latest possible start time of operation g of job k is then T−Σ_{h≥g}p(k)ₕ.

This choice of binary representation of operation start times requires several constraints to ensure only feasible solutions are obtained. (1) Each operation of every job must start exactly once; (2) Subsequent operations assigned to the same machine must start after prior operations are completed; and (3) The number of team specific operations active at any time must be less than or equal the number of teams available for that operation. The constraints may be modeled as follows.

$${\sum }_{t = {t}_{e ( g ( k ) )}}^{{t}_{l ( g ( k ) )}} {y}_{k , g , t} = 1 ∀ k ∈ \{ 0 , … , K - 1 \} , g ( k ) ∈ \{ 0 , … , H - 1 \} . \qquad Constraint 1$$

$${y}_{k , g , t} + {\sum }_{s = {t}_{e ( g + 1 ( k ) )}}^{t + P ( k ) g} {y}_{k , g + 1 , s} \leq 1 ∀ k ∈ \{ 0 , … , K - 1 \} , \qquad Constraint 2 a$$

$$g ( k ) ∈ \{ 0 , … , H - 2 \} , t ∈ \{ {t}_{e} , … , {t}_{l} \}$$

$$applied to operations within the same job ..$$

$${y}_{k , H - 1 , t} + {\sum }_{s = {t}_{e} ( {g}_{0} ( k + 1 ) )}^{t + {P ( k )}_{H - 1}} {y}_{k + 1 , 0 , s} \leq 1 \qquad Constraint 2 b$$

$$∀ n ∈ \{ 0 , … , N - 1 \} , k ( n ) \neq last job , t ∈ \{ {t}_{e} , … , {t}_{l} \}$$

$$applied to the first and last opeations between jobs assigned to the same machine .$$

$${\sum }_{k = 0}^{K - 1} {\sum }_{g ∈ {O ( k )}^{f}} {\sum }_{s = t - {p ( k )}_{g}}^{t} {y}_{k , g , s} \leq {L}_{f} \qquad Constraint 3$$

$$∀ f ∈ \{ 0 , … , F - 1 \} , t ∈ \{ 0 , … , T \} .$$

A goal is to find an optimal scheduling of jobs so that the time to complete all jobs is minimized. Another integer variable u∈{0, . . . , T} that represents the duration of time required to complete the last operation of the last job assigned to all machines may be used. The value of T is upper bound by the sum of all operation durations, corresponding to all operations being assigned to one machine. One or more embodiments may use a heuristic algorithm that may find a sub-optimal problem solution giving a reasonable estimate for T. The value of u may be modeled as a constraint.

$$u - {ty}_{k , H - 1 , t} \geq {p ( k )}_{H - 1} ∀ n ∈ \{ 0 , … , N - 1 \} , \qquad Constraint 4$$

$$k ( n ) = last job , t ( H - 1 ( k ) ) ∈ \{ {t}_{e} , … , {t}_{l} \} .$$

Since u must be greater than the duration of time required to complete the last operation of the last job assigned to all machines, when minimized may equal to the problem makespan.

Finally, one or more embodiments search for the solution y to the problem above that minimizes the duration of time to complete all jobs.

min H(y)=u

### Objective.

From the form of the objective and constraints, this is a linear problem and therefore may be readily solved with classical technology.

### Heuristic Method to Estimate Problem Formulation Bounds

As described above it is necessary to find reasonable bounds on the maximum number of assignment orders, M and the maximum time to complete the last operation of the last job on all machines, T. Our heuristic is a greedy algorithm that simply assigns jobs to machines in job order and sequentially starts any operation if the prior operation has completed and required team is available. From the resulting solution, T is extracted as is, as an optimal solution must do no worse and the largest order size is scaled by 25% to account for a possible optimal solution that assigns more jobs to the same machine. The algorithm is shown in FIG. 8.

### Example

Consider the construction of 4 wells using 2 drilling platforms and 1 casing/cementing crew and 1 production installation crew. Each well construction is comprised of the following operations: drill top section, case/cement top section, drill bottom section, case/cement bottom section, install production equipment. The duration of these operations is randomly varied. FIG. 9 shows the assignment and operation schedules derived from the heuristic algorithm (left panel) and quantum/classical procedure described above (right panel). Note the slight improvement of the optimized schedule which completes 2 times units earlier. The delay between jobsites using the same machine represents the required travel time.

### Larger Example

FIG. 10 shows a larger example involving the construction of 40 wells using 4 drilling platforms and 2 casing crews, 2 cementing crews, 1 logging crew and 1 production installation crew. The well comprises a top section, intermediate section and production section which is logged prior to casing and cementing. FIG. 10 shows the assignment and operation schedules derived from the heuristic algorithm and quantum/classical procedure described above.

Generally, the procedure improves the makespan, including that travel time of the drilling platforms between wells, by 10-20% corresponding to a substantial savings in cost. Using more randomly generated problem data, FIG. 11 shows the benefits compared to the purely heuristic method.

### Performance and Scalability

The benefit of this procedure is the solution advantage when including the quadratic components of the problem and the speed of solving the quadratic problem using a quantum computer. For the randomly generated problem set described above, the scalability shown in FIG. 12 is observed for solving the quadratic assignment problem using a quantum computer and the linear scheduling problem using a solver on a classical computing system. Excellent scaling is shown for the quantum computer which may solve the assignment of 100 wells using 8 drilling platforms in under 10 seconds.

Embodiments may be implemented on a special purpose computing system specifically designed to achieve the improved technological result. Turning to FIGS. 13.1 and 13.2, the special purpose computing system (1300) includes a classic computing system (1318) connected to a quantum computing system (1316). The quantum computing system (1316) includes a quantum computer that is a machine that uses the properties of quantum physics to store data and perform computations. In the quantum computer, the basic unit of memory is a quantum bit or qubit. Qubits are made using physical systems, such as the spin of an electron or the orientation of a photon. Qubits may also be inextricably linked together using a phenomenon called quantum entanglement. The result is that a series of qubits may represent different things simultaneously.

The basic unit of memory for the classic computing system is a bit, whereby each bit has a value of one or zero, but not both one and zero, at a single point in time. As shown in FIG. 13.1, the classic computing system (1300) may include one or more computer processors (1302), non-persistent storage (1304), persistent storage (1306), a communication interface (1312) (e.g., Bluetooth interface, infrared interface, network interface, optical interface, etc.), and numerous other elements and functionalities that implement the features and elements of the disclosure. The computer processor(s) (1302) may be an integrated circuit for processing instructions. The computer processor(s) may be one or more cores or micro-cores of a processor. The computer processor(s) (1302) includes one or more processors. The one or more processors may include a central processing unit (CPU), a graphics processing unit (GPU), a tensor processing units (TPU), combinations thereof, etc.

The input devices (1310) may include a touchscreen, keyboard, mouse, microphone, touchpad, electronic pen, or any other type of input device. The input devices (1310) may receive inputs from a user that are responsive to data and messages presented by the output devices (1308). The inputs may include text input, audio input, video input, etc., which may be processed and transmitted by the computing system (1300) in accordance with the disclosure. The communication interface (1312) may include an integrated circuit for connecting the computing system (1300) to a network (not shown) (e.g., a local area network (LAN), a wide area network (WAN) such as the Internet, mobile network, or any other type of network) and/or to another device, such as another computing device.

Further, the output devices (1308) may include a display device, a printer, external storage, or any other output device. One or more of the output devices may be the same or different from the input device(s). The input and output device(s) may be locally or remotely connected to the computer processor(s) (1302). Many different types of computing systems exist, and the aforementioned input and output device(s) may take other forms. The output devices (1308) may display data and messages that are transmitted and received by the computing system (1300). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (1300) in FIG. 13.1 may be connected to or be a part of a network. For example, as shown in FIG. 13.2, the network (1320) may include multiple nodes (e.g., node X (1322), node Y (1324)). Each node may correspond to a computing system, such as the computing system shown in FIG. 13.1, or a group of nodes combined may correspond to the computing system shown in FIG. 13.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1300) may be located at a remote location and connected to the other elements over a network.

The nodes (e.g., node X (1322), node Y (1324)) in the network (1320) may be configured to provide services for a client device (1326), including receiving requests and transmitting responses to the client device (1326). For example, the nodes may be part of a cloud computing system. The client device (1326) may be a computing system, such as the computing system shown in FIG. 13.1. Further, the client device (1326) may include and/or perform all or a portion of one or more embodiments of the invention.

The computing system of FIG. 13.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
applying an assignment model to project data using a quantum computing system to create an assignment schedule to assign a machine to a location at a time;
applying a scheduling model to the project data and the assignment schedule using a classic computing system to create an operation schedule to assign an operation to the location during the time with the machine; and
performing an action responsive to the operation schedule.

2. The method of claim 1, further comprising:
updating the project data to include an update to one or more of the location, the machine, and the operation;
applying the assignment model to the updated project data to create an updated assignment schedule; and
applying the scheduling model to the updated project data and the updated assignment schedule to create an updated operation schedule.

3. The method of claim 1, further comprising:
updating the project data to include an update to one or more of operation data and a team; and
applying the scheduling model to the updated project data and the assignment schedule to create an updated operation schedule without updating the assignment schedule.

4. The method of claim 1, further comprising:
collecting the project data comprising one or more of location data, machine data, and operation data.

5. The method of claim 1, wherein the operation schedule comprises operations identified as one of drill surface section, case surface section, cement surface section, drill next section, case next section, cement next section, drill production section, log production section, case production section, cement production section, and install production equipment.

6. The method of claim 1, further comprising:
collecting the project data comprising team data.

7. The method of claim 1, wherein the operation schedule identifies teams identified as one of drilling rig team, casing team, cement team, wireline logging team, and production team.

8. The method of claim 1, wherein the project data identifies one drilling rig team per machine, less than one casing team per machine, less than one cement team per machine, less than one wireline logging team per machine, and less than one production team per machine.

9. The method of claim 1, further comprising:
applying a heuristic model to the project data using the classic computing system to create a heuristic assignment schedule and a heuristic operation schedule to define a makespan upper limit.

10. The method of claim 1, further comprising:
verifying the assignment schedule is feasible using a makespan upper limit generated from a heuristic model.

11. The method of claim 1, wherein performing the action comprises:
displaying a construction plan comprising the assignment schedule in an assignment graph.

12. The method of claim 1, wherein performing the action comprises:
displaying a construction plan comprising the operation schedule in an operation graph.

13. The method of claim 1, wherein performing the action comprises:
automatically generating a message containing one or more of the project data, the assignment schedule and the operation schedule; and
transmitting the message to one or more users over a computer network in real time, wherein the message is displayed on a user device in a construction plan comprising a location graph comprising the location and the machine.

14. A system comprising
at least one processor and
an application that, when executing on the at least one processor, performs:
applying an assignment model to project data using a quantum computing system to create an assignment schedule to assign a machine to a location at a time;
applying a scheduling model to the project data and the assignment schedule using a classic computing system to create an operation schedule to assign an operation to the location during the time with the machine; and
performing an action responsive to the operation schedule.

15. The system of claim 14, wherein the application further performs:
updating the project data to include an update to one or more of the location, the machine, and the operation;
applying the assignment model to the updated project data to create an updated assignment schedule; and
applying the scheduling model to the updated project data and the updated assignment schedule to create an updated operation schedule.

16. The system of claim 14, wherein the application further performs:
updating the project data to include an update to one or more of operation data and a team; and
applying the scheduling model to the updated project data and the assignment schedule to create an updated operation schedule without updating the assignment schedule.

17. The system of claim 14, wherein the application further performs:
collecting the project data comprising one or more of location data, machine data, and operation data.

18. The system of claim 14, wherein the operation schedule comprises operations identified as one of drill surface section, case surface section, cement surface section, drill next section, case next section, cement next section, drill production section, log production section, case production section, cement production section, and install production equipment.

19. The system of claim 14, wherein the application further performs:
collecting the project data comprising team data.

20. A non-transitory computer readable medium comprising instructions that, when executed by one or more processors, perform:
applying an assignment model to project data using a quantum computing system to create an assignment schedule to assign a machine to a location at a time;
applying a scheduling model to the project data and the assignment schedule using a classic computing system to create an operation schedule to assign an operation to the location during the time with the machine; and
performing an action responsive to the operation schedule.
